(19) United States
(12) Patent Application Publication
(10) Pub. No.: US 2010/0287957 A1
(43) Pub. Date: Nov. 18, 2010

(54) Pipe-in-Pipe in RCC for Subsea Transfer of Cryogenic Fluids

(76) Inventor: Xuejie Liu, Houston, TX (US)

Correspondence Address: XUEJIE LIU, 12518 BOHEME DR., HOUSTON, TX, 77024, US

(21) Appl. No.: 12/778,076

(22) Filed: May 11, 2010

Related U.S. Application Data
(60) Provisional application No. 61/177,598, filed on May 12, 2009.

(51) Int. Cl. F17C 9/00; F16L 9/14; F16L 9/18

(52) U.S. Cl. 62/50.7; 138/149

(57) ABSTRACT

The present invention provides a subsea transfer system for cryogenic fluids comprising reinforced concrete conduits (RCC), and stationary rollers that are anchored to the bottom of RCC, and one or more pipe-in-pipe that is supported on rollers along with insulation in the annulus. Each RCC is pre-cast with spigot and bell ends, and fits together with rubber gasket/sealant at joints. RCCs are installed first to form a dry path for pipeline(s). Once the RCC and stationary rollers are installed, a cryogenic pipeline having pipe-in-pipe configuration is then pulled into the RCC through and supported on the stationary rollers. As such a robust RCC protected pipe-in-pipe system for transfer of cryogenic fluids under water are established.

### CROSS-REFERENCE TO RELATED APPLICATIONS

This application claims priority of U.S. Provisional Patent Application Ser. No. 61/177,598 filed on May 12, 2009.

U.S. Patent Documents

| | | | |
|---|---|---|---|
| 3,379,027 | April 1968 | Mowell | 62/53 |
| 3,388,724 | June 1968 | Mowell | 138/155 |
| 3,530,680 | September 1970 | Gardner | 61/72.3 |
| 4,718,459 | January 1988 | Adorjan | 138/105 |
| 4,826,354 | May 1989 | Adorjan | 405/158 |
| 5,592,975 | January 1997 | Wissmann et al | 138/112 |
| 6,003,559 | December 1999 | Baker | 138/108 |
| 6,012,292 | January 2000 | Gulati and Silverman | 62/50.7 |
| 6,199,595 B1 | March 2001 | Baker | 138/149 |
| 7,494,155 B2 | February 2009 | Offredi | 285/47 |

### Other Publications:

Colin McKinnon (2007), “Technical Challenges of Subsea LNG Pipelines,” J P Kenny Ltd, http://events.sut.org.uk/past events/2007/070322/LNGpipeline.pdf.

### STATEMENT REGARDING FEDERALLY SPONSORED RESEARCH OR DEVELOPMENT

Not Applicable

### BACKGROUND OF THE INVENTION

1. Field of Invention

The present invention relates generally to transfer of cryogenic fluids between two locations that are separated by a body of water. Specifically, the present invention provides reinforced concrete conduit to host cryogenic pipelines with stationary roller supports.

2. Description of the Related Art

The existing cryogenic pipelines at LNG receiving and loading terminals are either supported above water, or within an underground tunnel. Above-water pipeline systems for cryogenic fluid transfer are widely used along with supporting structures such as jetty or trestle. Those LNG pipelines are on the dry environment, and are insulated with materials such as polyisocyanurate (PIR) and an outer water barrier such as metal/plastic cladding. They are easily accessed by crew, but are very costly and require maintenance.

Underground tunnels have been used for river crossings, mountain crossings, strait crossings, and subway in cities. Two tunnels are built to host pipeline transfer system of cryogenic fluids: one at the Cove Point receiving terminal in Maryland and the other at Ohgishima, Yokohama in Japan. The Cove Point tunnel has a rectangular shape, and is 8.4 m wide and 4.9 m high. It was made of concrete with steel outer shell. It was floated out and placed in an open trench. The Ohgishima tunnel has cylindrical shape with an internal diameter of 7.2 m. It is located up to 60 m below the seabed. Both tunnel sections are formed with more than one concrete shell segments in the circumferential direction. They are large in size in order to provide access for crew and construction equipment. In addition, the tunnel creates a dry environment under water. The LNG pipelines inside are insulated with a conventional method, just like the pipeline on trestle. Building those big tunnels is costly and time-consuming.

Subsea cryogenic pipelines have been proposed, and a number of articles have described such a system. McKinnon published an article entitled “Technical Challenges of Subsea LNG Pipelines” and discussed the systems proposed by several companies. They include:

ITP describes a subsea system for LNG transfer using INVAR (36% Nickel steel with very low thermal expansion coefficient) for transfer pipe and the annulus between the transfer pipe and casing pipe is filled with multilayer insulation. ITP has also described a triple wall LNG pipe system comprising an outer pipe made of carbon-steel pipe, intermediate pipe and 36% Nickel steel inner pipe (invar). The intermediate pipe is made of either carbon steel or stainless steel.

Chart VIP system consists of a stainless steel inner pipe and carbon steel outer pipe while the annulus between the two pipes is maintained at a very low pressure (vacuum). Technip's PiP system consists of inner pipe (made of invar) and outer pipe (stainless steel or carbon steel) with Aerogel filled in the annulus for insulation. GTT's PiPiP system consists of inner and intermediate pipes made of invar and outer pipe made of carbon steel along with concrete for weight filled in the outer annulus. Fluor uses 9% nickel steel for the inner pipe and carbon steel for outer pipe along with Aerogel in the annulus.

A number of patents have also disclosed such a subsea pipeline system. They include:

U.S. Pat. No. 3,379,027 to Mowell includes rollers that are attached to the outer surface of inner pipe and used for pulling the inner pipe into the casing pipe. A layer of concrete coating is used for stabilizing the pipe-in-pipe system on the seabed.

U.S. Pat. No. 3,388,724 to Mowell discloses a subsea cryogenic system with bellows at intervals to absorb thermal expansion of each transfer pipe section and the other end of the transfer pipe section is fixed with a casing pipe.

U.S. Pat. No. 3,530,680 to Gardner discloses a subsea pre-stressed system for cold fluids. The inner pipe is compressed first and then welded to the outer pipe. Rollers are used for pulling certain length of the insulated inner pipe into the casing pipe before the pre-stressing. This design has been used at Searsport in Maine for transfer of liquefied ammonia between onshore facilities and tankers offshore.

U.S. Pat. No. 5,592,975 to Wissmann et al disclose a glide tube ring made of fiberglass-reinforced polyethylene with low friction coefficient for a tube-in-tube system.

U.S. Pat. No. 6,003,559 and No. 6,199,595 B1 to Baker, disclose an improved spacer and wheels to prevent damage to the casing pipe and inner pipe when the inner pipe is pulled into the casing pipe. More than one pipe can be encased by insulation and inserted into the outer casing pipe in a bundle.

U.S. Pat. No. 6,012,292 to Gulati and Silverman discloses a cryogenic system comprising a transfer pipe and a return line that is positioned inside the transfer pipe, and an out jacket for protection. This system can be installed on the seabed (underwater) as subsea application. The jacket pipe is encased in a layer of concrete to provide stability against wave, current, buoyancy, or other forces.

U.S. Pat. No. 7,494,155 to Offredi discloses a thermally-insulated pipeline for the transportation of a cryogenic liquid. The system consists of three coaxial pipes, one inner pipe made of a material having a low thermal expansion coefficient, a middle pipe and an outer pipe made of steel. The pipes are linked by linking parts which join sections of each respective pipe and take up the loads produced by thermal expansion or contraction when the pipes change temperature.

The subsea cryogenic pipeline systems above have the following common features: a pipe-in pipe configuration. The inner pipe is made of austenitic stainless steels, 9% nickel steel, invar, etc, and the casing pipe is made of metal such as carbon steel. The casing pipe is used to keep water away from insulation material and to protect the transfer pipe against external forces. Insulation is typically filled within the annulus (e.g. expanded foam, multilayer insulation, vacuum insulation panel, aerogel beads, etc). Concrete coating is attached to the casing pipe and provides weight to counterbalance the buoyancy and stabilize the system on the seabed. This layer of concrete coating for weight is weak regardless its thickness (typically varying from 0.5 in to 5 in), does not have strength to share any loads with metal pipes. Some systems have a third metal pipe for additional protection and weight.

When rollers/wheels are used for friction reduction, they are attached to the outer surface of the inner pipe and move along with the inner pipe.

All these systems require a completed assembly (from concrete coating to inner pipe) of a string onshore (anywhere from 100 m to 1 km long) and then a tow method is used to pull the completed string into the seabed. These systems have the same shortcomings: not retrievable and subjected to damage by external forces such as shipping anchors and sinking ships. If the pipe-in-pipe is damaged at one location, the whole transfer system is in jeopardy and a total replacement may be required.

In U.S. Pat. No. 3,379,027 to Mowell, rollers are fixed to the transfer pipe (inner pipe) and can be used to withdrawn the transfer pipe from its casing pipe if repairs are necessary. However, this system can be easily damaged by external forces. In addition, any water leaks through the casing pipe wall or outgress of cryogenic fluid through the wall of transfer pipe will totally destroy the system.

Concrete is well known for its high compressive strength and steel is for high tensile strength. Reinforced concrete pipe (RCP) or box (RCB) has been widely used for water and sewage systems. Pre-stressed concrete pipe has also been used for larger diameter water system. Reinforced concrete conduits are a desirable solution in terms of corrosion resistant in seawater, protection from anchors or sinking ship. There is an ergonomic need to build a robust subsea transfer system with cost-effective RCC to host cryogenic pipelines.

### BRIEF SUMMARY OF THE INVENTION

The present invention provides a subsea transfer system for cryogenic fluids comprising reinforced concrete conduits (RCC), and stationary rollers that are anchored to the inner wall of RCC through pre-embedded studs and used to support a metal pipe-in-pipe with insulation in the annulus.

RCC extends from onshore to a vertical shaft offshore with rubber gasket at bell-spigot joints of segments for sealing. Each RCC segment is pre-cast with a length in a few meters (e.g., 1-6 m). There are pre-embedded studs at the bottom of each RCC segment. Stationary rollers are fixed to the studs. When the RCC and rollers are in place, a pipe-in-pipe transfer line is then pulled into RCC through rollers and supported on the rollers thereafter.

In this detachable system, RCC and rollers are installed first. Any water leakage at joints can be stopped and any adjustment can be made to rollers (e.g., alignment) since crews have temporary access to the inside of RCC. The RCC has a relatively thick wall (e.g., 12-in) with a specific gravity of around 1 (larger than 1 when it goes through a trench) in order to reduce jacking force. The RCC provides not only the strong protection from external forces (e.g., shipping anchors) and seawater intrusion, but also eliminate the submerged weight requirement for pipe-in-pipe transfer line and provide anchor for stationary rollers. The rollers transport pipelines during installation and support pipelines afterward. Most importantly, the rollers reduce friction between the RCC and metal casing pipe, allowing tension in the inner pipe to be shared by compression in the metal casing pipe. When used with flexible loading arms (allowing some movement at offshore end of the transfer line), this roller support reduces the thermal stress significantly for operating conditions.

Accordingly, it is a principal object of the invention to provide a strong and waterproof shield for transfer of cryogenic fluids across a body of water as well as a retrievable feature in case of repair or upgrade.

It is another object of the invention to provide multiple pathways in various sizes through which a number of pipelines can be used for transfer of cryogenic fluids at terminals.

It is another object of the invention to provide a method so that thermal stresses in the system can be reduced significantly for operating conditions.

### BRIEF DESCRIPTION OF THE DRAWINGS

The system, construction method and advantages of the present invention will be better understood by referring to the drawings, in which:

FIG. 1 is a cross-sectional view of the subsea transfer system;

FIG. 2 is a detailed view of roller support;

FIG. 3 is a partial cross-section view of a reinforced concrete conduit along 3-3 line in FIG. 1;

FIG. 4 is a partial cross-sectional view of an intermediate jacking station;

FIG. 5 is a cross-sectional view of a rectangular box with interior arrangement;

FIG. 6 is a cross-section view of a reinforced concrete cylinder with a pipe-in-pipe on rollers.

FIG. 7 is a cross-section view of the subsea transfer system with details at ends.

### DETAILED DESCRIPTION OF THE PREFERRED EMBODIMENT

1. System

A simple subsea transfer system of the present invention is illustrated in FIG. 1. The system comprises a reinforced concrete conduit (RCC) 11, double rollers 2 that sit on the bottom of RCC, and a metal casing pipe 13 supported on double rollers 2. Within metal casing pipe 13, there is an inner metal pipe 14 with insulation 15 filled in the annulus in between. Tensioner 16 is located at each corner of RCC 11 and puts in RCC 11 in compression.

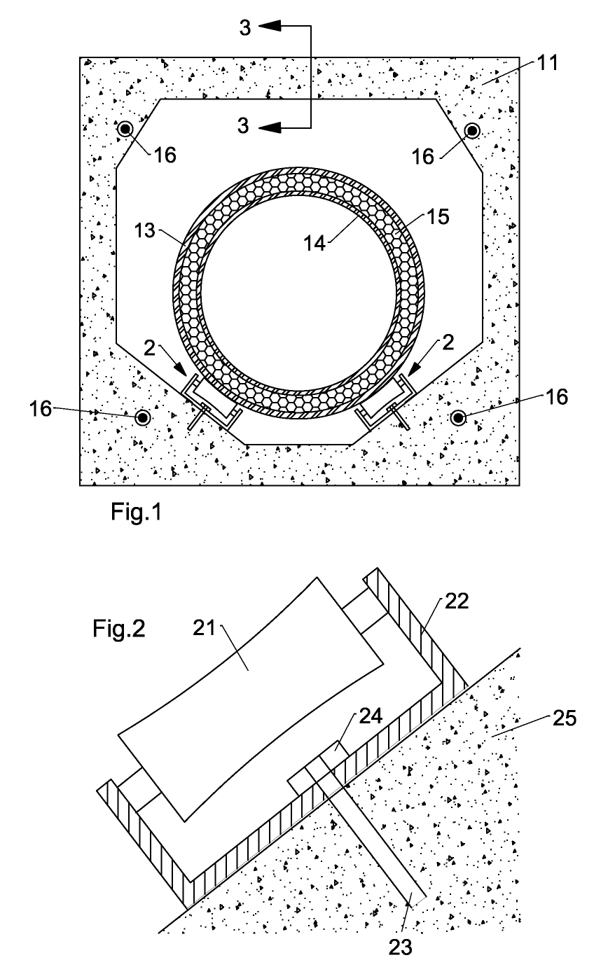

Refer now to FIG. 2, a roller 21 is attached to both walls of a U-shaped support 22. The bottom of U-shaped support 22 is anchored to concrete bottom 25 by tightening nut 24 onto a pre-imbedded stud 23.

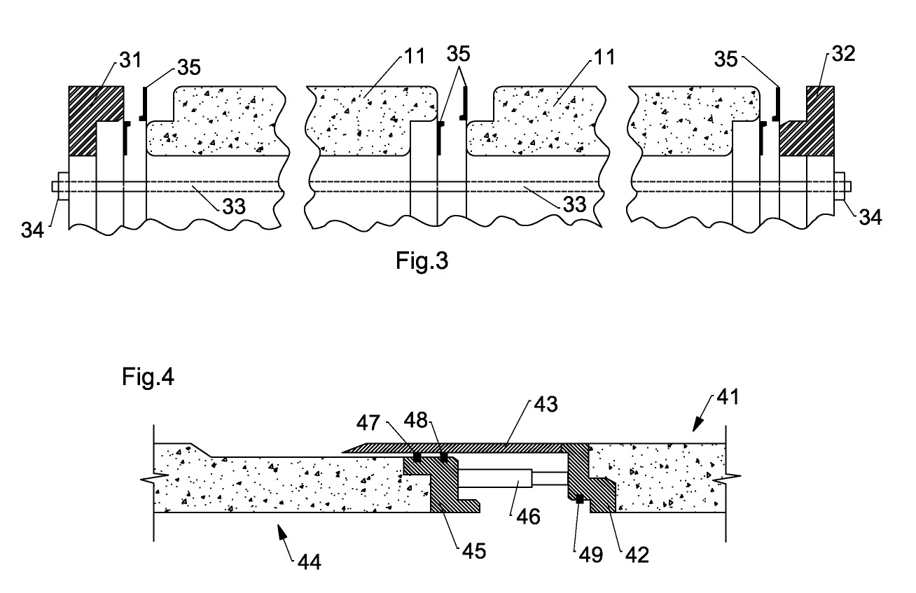

FIG. 3 shows two reinforced concrete conduits 11, each having a spigot end and socket end. Threaded bar 33 runs through reinforced concrete conduits 11 and is anchored to socket end plate 31 and spigot end plate 32. Rubber gasket ring 35 is used at each joint and provides sealing against water or debris intrusion. Threaded bar 33 is located within pre-made holes around each corner of RCC. Nut 34 is tightened onto threaded bar 33 to apply tensile force.

When two locations are at a long distance apart, multiple strings are needed to form a continuous pathway with intermediate jacking FIG. 4 shows an intermediate jacking station located between a front string 41 and rear string 44. The front string 41 has a female end plate 42 and a metal box 43 is welded to female end plate 42. Primary gasket seal 47 and secondary gasket seal 48 are sit in the groove of male end 45 of rear string 44. Both gasket seals are able to slide over the inner surface of metal box 43. A number of jacks 46 are uniformed distributed around metal box wall between two end plates (female end plate 42 and male end plate 45). During intermediate jacking, rear string 44 is used as an abutment for jacks 46 to push front string 41 forward. After jacks 46 reach their full stroke, rear string 44 is pushed forward while jacks 46 are retreated. Once jacks 46 are fully retreated, next round of jacking can be made.

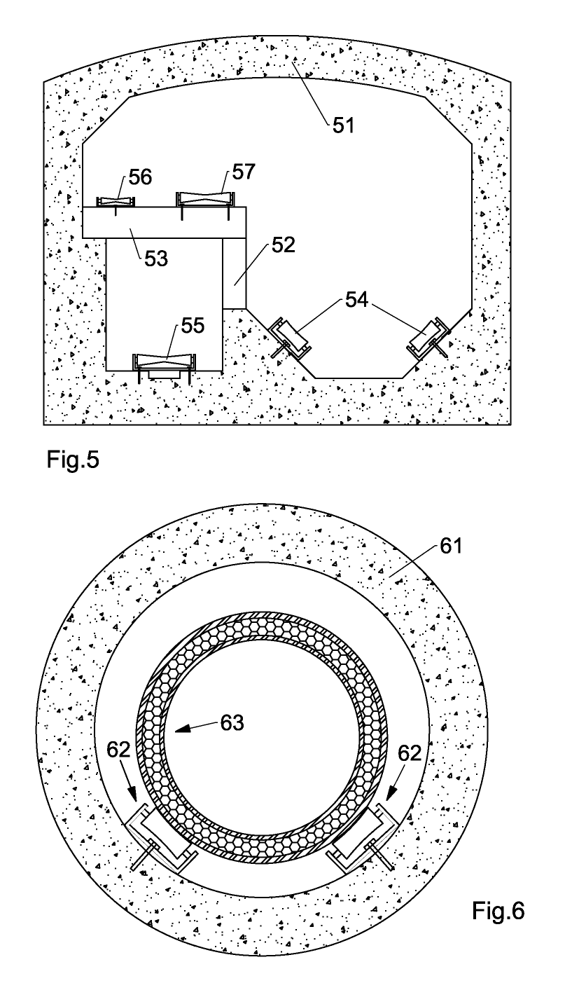

As an application of this invention, FIG. 5 shows a reinforced concrete (RC) box 51 with partition wall 52 and partition floor 53. Below partition floor 53, recirculation-line roller 55 is sitting on the bottom of RC box 51. Umbilical-line roller 56 and vapor-line roller 57 are sitting on partition floor 53. Transfer-line roller 54 is sitting on the bottom of RCC box 51 on the other side of partition wall 52. For simplicity, all pipelines are not shown, and each roller has a name representing the pipeline on it. For example, transfer-line roller 54 is for supporting transfer line of cryogenic fluids.

As variation of this invention, there are other cross-section shapes as well as various pipeline arrangements. For example, FIG. 6 shows a RCC 61 in a cylindrical shape with rollers 62 to support a pipe-in-pipe transfer line 63.

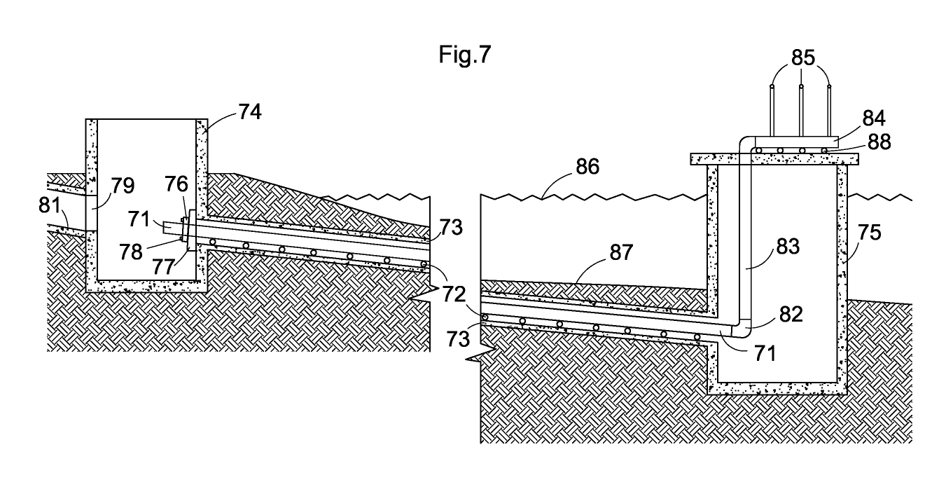

FIG. 7 shows details at both ends of the subsea system. RCC 73 is under seabed 87 and hosts pipeline 71 and pipe rollers 72. At the onshore end, RCC 73 is tied to the wall of onshore shaft 74. Pipeline 71 is anchored to a wall of onshore shaft 74 using steel plate 77, pipe flange 76 and nuts 78. On the opposite side wall of onshore shaft 74, there is a hole 79 and RCC extension 81, providing temporary pass for pulling pipeline 71 through. At the offshore end, RCC 73 is tied to a wall of offshore shaft 75, which extends upward above water level 86. A riser 83 is fluidly connected to pipeline 71 below with bend 82, and to a header 84 above. Flexible loading arms 85 are fluidly connected to header 84 that is supported on platform rollers 88. The offshore end of pipeline 71 is able to expand or contract.

2. Installation Method

Installation method is a key for the heavy reinforced concrete conduit. It is preferably that these RCCs are pre-cast on site. Their size and wall thickness are carefully selected in order to achieve a desirable specific gravity (between 0.9 to 1.2). Different density of concrete may also be used to adjust the submerged weight of RCC. With the desirable specific gravity, these RCCs are light in water or mud, and can be easily pushed forward with a minimum number of intermediate jacking stations. In addition, alignment control is also very important when making a trench or bore in the ground (including seabed or river bed). It is preferred that a straight path is targeted for the trench or bore.

For installation of RCC in trench, a conduit string is made onshore, comprising of a number of pre-cast RCC segments. Steel bars are running through the concrete conduits and anchored to the end metal plates. As the steel bars are tightened in tension, the RCC segments are compressed together to form a string with a water-tight inner space(s). A temporary end cap is needed at the front end to keep water out of RCC string. Temporary rails and rollers are needed around the coast line in order to reduce friction and to guide the string into the trench on the seabed. The trench is preferably made simultaneously with the advance of RCC.

For RCC installation with micro-tunneling, a vertical shaft may be needed at entrance and/or exit points, providing a relatively straight path for boring.

I claim:

1. A system for transfer of cryogenic fluids under a body of water, such a system comprising:
reinforced concrete conduit (RCC);
a row of rollers and roller supports that are anchored to the bottom of said RCC;
pipe-in-pipe for cryogenic fluids with insulation means in the annulus between the metal pipes;
in which said pipe-in-pipe is pulled in through and supported on said rollers.

2. The transfer system of claim 1 extends from onshore to a vertical shaft at a loading platform offshore.

3. The transfer system of claim 1 extends from a storage tank to another storage tank separated by a body of water, including a river and shipping channel.

4. The transfer system of claim 1, said RCC has a straight path staring at a vertical shaft and ending another vertical shaft.

5. The transfer system of claim 1, said RCC consists of a number of pre-fabricated segments and being prestressed with tendons that are anchored to the metal plates at the ends to form a continuous pathway.

6. The transfer system of claim 2, said RCC has a gentle slope with a high end onshore and a low end at said loading platform.

7. The transfer system of claim 1, said RCC hosts more than one pipeline with designated roller support for each pipeline.

8. The transfer system of claim 1, said RCC uses rubber gaskets for sealing at its joints.

9. The transfer system of claim 1, said RCC uses sealant for sealing at its joints.

10. The transfer system of claim 1, partition wall and floor are installed inside RCC, and a pipeline is supported by a row of rollers that are fixed to said partition floor.

11. The transfer system of claim 1, both inner and outer pipes of said pipe-in-pipe are made of metals that are resistant to cold.

12. The transfer system of claim 1, said pipe-in-pipe uses insulation means selected from a group comprising vacuum, arogel, vacuum insulated panel, and other insulation materials.

13. The transfer system of claim 1, said rollers are cold resistant.

14. The transfer system of claim 1, said RCC is ended at an onshore shaft.

15. The transfer system of claim 14, said pipe-in-pipe transfer line is anchored to the wall of said onshore shaft.

16. The transfer system of claim 15, said onshore shaft has an exit hole on its wall, allowing passage of pipe-in-pipe transfer line during installation.

17. The transfer system of claim 2, said pipe-in-pipe transfer line is fluidly connected to a riser in said vertical shaft offshore.

18. The transfer system of claim 17, said riser is fluidly connected to flexible loading arms through a loading header.

19. The transfer system of claim 18, said loading header is supported on rollers.

20. The transfer system of claim 18, said loading header is free to slide.
